(19) United States
(12) Patent Application Publication
(10) Pub. No.: US 2024/0092277 A1
(43) Pub. Date: Mar. 21, 2024

(54) Steering Wheel Attachment for Phone

(71) Applicant: Janice Hinkle, Kingman, AZ (US)

(72) Inventor: Janice Hinkle, Kingman, AZ (US)

(21) Appl. No.: 17/945,893

(22) Filed: Sep. 15, 2022

(51) Int. Cl. B60R 11/02

(52) U.S. Cl. CPC B60R 11/0241; B60R 2011/001

(57) ABSTRACT

The pivot ring is the only product of its kind that positions the phone directly in the center of the steering wheel to ensure drivers are able to maintain proper eye contact while driving and using their devices, simultaneously, if needed or of habit. This unprecedented device is uniquely designed with durable, high-quality materials to ensure long-term sustainability, comes in a wide variety of colors and can be used for any and all car makes and models, per consumer preference.

### BACKGROUND

Using a cell phone when operating a vehicle creates enormous potential for accidents, injuries and/or fatal occurrences on driving roads, as it is an easy distraction. Although efforts to stop phone usage while driving exist, many drivers continue to do so regardless of the real consequences of such behavior. There have been no products available as original equipment or as an aftermarket to address this problem.

An apparatus to simplify the use of a cell phone while operating a vehicle is not being met by any known device or system at present. There have been no products available as original equipment or as an aftermarket to address this problem either.

### SUMMARY OF THE INVENTION

The main purpose of the steering wheel attachment for phone is to provide users with a phone case that attaches to a vehicle's steering wheel to prevent individuals from holding their phone while driving.

A steering wheel attachment comprising a steering wheel cover configured to attach to the steering wheel via perimeter portions thereof and comprise an axial portion thereof. The disclosure also includes a pocket attached to the axial portion and configured to secure a cell phone thereto, wherein the pocket defines openings for audio and operations. The disclosure further includes attachments for the pocket to the axial portion and for the perimeter portions to the steering wheel.

### BRIEF DESCRIPTION OF THE DRAWINGS

FIG. 1 is a front elevational view of the steering wheel attachment for phone in accordance with an embodiment of the present disclosure.

FIG. 2 is a top elevational view of the steering wheel and attachment for a cell phone in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

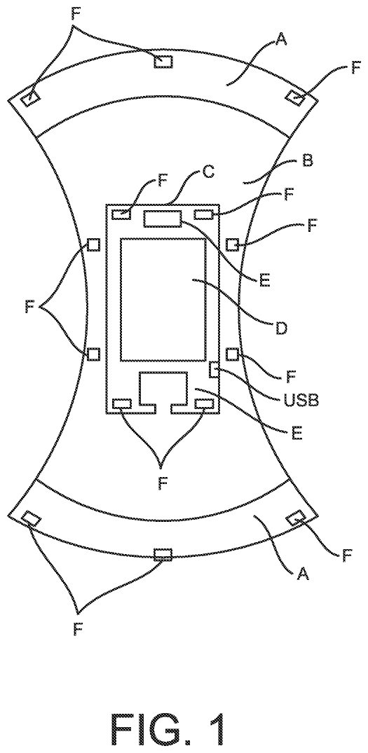

FIG. 1 is a front elevational view of the steering wheel attachment for phone showing: 3 snaps or Velcro referenced as A, vinyl or leather cover comes in different colors referenced as B, top opening to slide phone in referenced as C, clear plastic pocket referenced as D, and front opening referenced as E, in accordance with an embodiment of the present disclosure. The attachments or fasteners F are shown for securing the steering wheel cover to the steering wheel perimeter and axial portions and for securing the pocket to the steering wheel cover. The USB opening defined in the pocket serves as an operational opening and also for audio and microphone pickups.

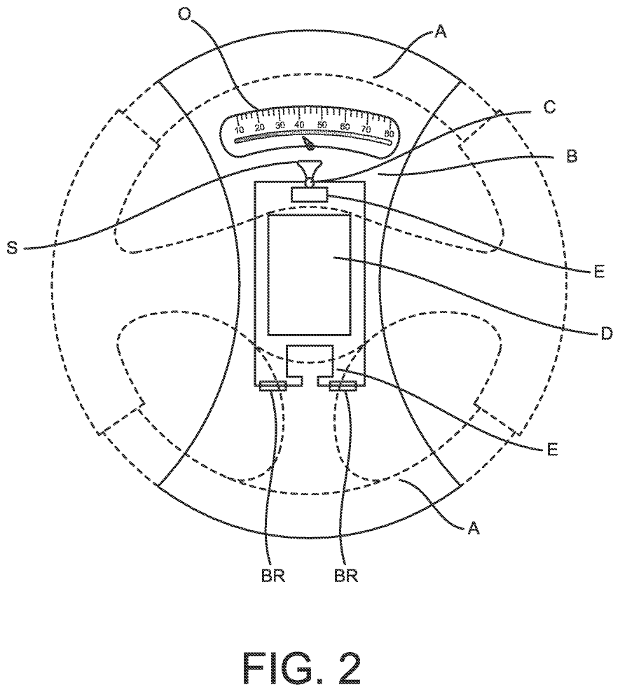

FIG. 2 is a top elevational view of the steering wheel and attachment for a cell phone in accordance with an embodiment of the present disclosure. The view shows the brackets BR configured to receive and attach a bottom portion of the phone to the disclosure. The snap S secures a top of the cell phone to the disclosed steering wheel attachment. Other limitations are as viewed and referenced as per FIG. 1 limitations and references. An opening O in the disclosed cover B allows viewing of a vehicle's speedometer and performance dials. The opening can be 2 inches tall by 4 inches wide and vary according to car model and instrument panel designs.

The present disclosed steering wheel attachment for phone, also known as the “Pivot Ring” offers a modern accessory that provides a hands-free solution to using a phone while driving in effort to significantly reduce the likelihood of vehicle collision. Meant to complement the initial design of a typical steering wheel, the pivot ring introduces a novel vinyl or leather cover that snaps onto the entire surface of a steering wheel. Users simply slide their devices into the clear plastic pocket located in the center of the cover empowering them to access their devices as they normally would, as the unit would be securely present in eye view. With the pivot ring, users will no longer have to take their eyes off of the road to look for their phones or navigate them for varying reasons, such as: managing in-coming and out-going calls, for destination map support, controlling music, and other options for using a mobile device. This innovative, top-quality product ensures a more convenient means of using their cellular devices while driving.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A steering wheel attachment comprising:
a steering wheel cover configured to attach to the steering wheel via perimeter portions thereof and comprise an axial portion thereof;
a pocket attached to the axial portion and configured to secure a cell phone thereto, wherein the pocket defines openings for audio and operations; and
a plurality of attachments for the pocket to the axial portion and for the perimeter portions to the steering wheel.

2. The steering wheel attachment of claim 1, wherein the steering wheel cover covers a first portion of the steering wheel and covers an equal and opposite second portion of the steering wheel.

3. The steering wheel attachment of claim 1, wherein the plurality of attachments comprise a plurality of snaps on the wrap at the perimeter thereof.

4. The steering wheel attachment of claim 1, wherein the plurality of attachments comprise a snap post on an inner side of the steering wheel cover perimeter portions and snap post receivers on complementary portions of the steering wheel.

4. The steering wheel attachment of claim 1, wherein the plurality of attachments comprise a hook and a loop material on one side of a wrap around and another side of the wrap around portions of the steering wheel.

5. The steering wheel attachment of claim 1, wherein the plurality of attachments comprise a hook and a loop material on an inner side of the steering wheel cover perimeter portions and on complementary portions of the steering wheel.

6. The steering wheel attachment of claim 1, wherein the plurality of attachments comprise a magnet on one side of a wrap around portion of the steering wheel cover and a complementary magnet on another side of the wrap around portion.

7. The steering wheel attachment of claim 1, wherein the plurality of attachments comprise a magnet on an inner side of the steering wheel cover perimeter portion and a complementary magnet on complementary portions of the steering wheel.

8. The steering wheel attachment of claim 1, wherein the pocket comprises clear plastic material.

9. The steering wheel attachment of claim 1, wherein the pocket operations openings comprise a Universal Serial Bus (USB) connector opening.

10. The steering wheel attachment of claim 1, wherein the pocket operations openings include a touchscreen opening.

11. The steering wheel attachment of claim 1, wherein the pocket operations openings include a front button opening.

12. The steering wheel attachment of claim 1, wherein the pocket comprises an end flap over an insertion opening thereof for holding in the cell phone when upside down according to a turn position of the steering wheel.

13. The steering wheel attachment of claim 1, wherein the pocket comprises a hook and a loop closure of an insertion opening thereof for holding the cell phone inside the pocket despite an upsidedown position.

14. The steering wheel attachment of claim 1, wherein the steering wheel cover resembles a double ax blade shape as seen from a broad side thereof.

15. The steering wheel attachment of claim 1, wherein the steering wheel cover comprises three spokes from the axial portion thereof.

16. The steering wheel attachment of claim 1, wherein the steering wheel cover comprises two spokes from the axial portion thereof.

17. The steering wheel attachment of claim 1, wherein the steering wheel cover comprises 5 spokes from the axial portion thereof.

18. The steering wheel attachment of claim 1, wherein the steering wheel cover encases the entirety of the steering wheel.

19. The steering wheel attachment of claim 1, wherein the pocket is sewn into the steering wheel cover.
